(19) United States
(12) Patent Application Publication
(10) Pub. No.: US 2008/0093394 A1
(43) Pub. Date: Apr. 24, 2008

(54) Metal and plastic dispensing lid

(75) Inventors: Richard L. Peterson, Roscoe, IL (US); Gregg Hoffman, Rockford, IL (US); Gordon E. VerWeyst, Rockford, IL (US); George Solowiejko, Rockford, IL (US)

Correspondence Address: REINHART BOERNER VAN DEUREN P.C., 2215 PERRYGREEN WAY, ROCKFORD, IL, 61107, US

(73) Assignee: J.L. Clark, Inc., Rockford, IL (US)

(21) Appl. No.: 11/585,749

(22) Filed: Oct. 24, 2006

(51) Int. Cl. B67D 3/00

(52) U.S. Cl. 222/480; 222/565

(57) ABSTRACT

A serving lid for use with a container having a threaded upper exterior is provided. The serving lid includes a metal lid, a plastic liner, and a metal cap. The metal lid has a skirt, a lid top with a sidewall and convex cover, and a shoulder between the lid top and skirt. The skirt has a curled bottom and the lid top includes a lid dispensing port. The plastic liner has a flange is abutted against the shoulder and a distal end is clamped under the curled end to secure the plastic liner within the metal lid. A threaded interior of the plastic liner mates with the threaded upper exterior neck of the plastic container. The metal cap has a cap dispensing port and is rotatably coupled to the lid top.

### FIELD OF THE INVENTION

This invention generally relates to dispensing lids and, in particular, dispensing lids for containers holding spices, powders and other granular material.

### BACKGROUND OF THE INVENTION

A conventional spice container holds spices, powders and other granular material. The contents held in the container are trapped within and can be dispensed from the container by a serving lid.

One exemplary known metal server lid construction includes for example, an inner metal lid and an outer metal cap as is pictured in a J. L. Clark marketing publication entitled “Spice Product Market.” According to this server lid construction, the inner lid includes an inner dispensing port while the outer cap includes a variety of variously sized and shaped outer dispensing ports (e.g., a pour port, a sprinkle port, etc.). The lid and cap also have a circular interface (e.g. along respective cylindrical walls) such that these serving lid components can be rotated relative to each other about the circular interface. When the cap is rotated relative to the lid, the lid's dispensing port can be aligned partially or fully with one of the cap's dispensing ports such that the contents of the container can be dispensed at various selected rates. The cap can also be rotated relative to the lid so that the dispensing ports do not align but are covered with a solid segment so that the contents of the container remain trapped within the container and are not dispensed.

In order to afford rotation while at the same time axially retaining the outer cap, a plurality of radially outwardly-projecting detents about a circle are swaged in the cylindrical sidewall of the lid and a radially outwardly-projecting circular bead is swaged in the cylindrical sidewall of the outer cap. The relatively thin metal of the cap and lid affords these metal forming operations. With the detents and the circular bead engaged together, axial movement of the outer cap relative to the lid is prevented. However, the outer cap is still permitted to rotate relative to the lid (with the application of slight to moderate manual force to overcome frictional engagement between the cap and lid) for selectively dispensing or trapping the contents within the container.

In addition to providing a suitable arrangement by which the outer cap may be rotatably coupled to the lid, one significant advantage of the use of metal for the serving lid is that it also permits lithographic images to be printed directly on the serving lid. The metal also provides for a decorative and more reflective finish. This can be seen on the noted publication above, which shows in contrast that rectangular plastic lids do not afford such decorative options. The lithographic prints on the metal spice container lid are employed for decorative and marketing reasons to make the container and the serving lid more aesthetically pleasing to a consumer and/or to convey information to the consumer about the contents.

While this metal server lid has proved to be commercially successful, unfortunately its application has been limited to use on metal containers. As may be seen from the exterior of the spice container, the inner cap of this server lid construction has a free edge which is suitable for curling and that is curled with the corresponding top free edge of a cylindrical sheet metal container. Thus, the inner cap is permanently secured to the sheet metal container through the curl which thereby better ensures product freshness and prevents granular material from leaking out of the container.

While plastic serving lids for non-metal spice containers are known, such as shown by U.S. Pat. No. 5,183,171 to Pherigo and U.S. Pat. No. 4,361,250 to Foster (both assigned to the present assignee), these lids do not provide the decorative printing options or other features available with metal. While plastic material does afford more complex server lid options, these more complex server lid structures or options are not of the type that can be made readily from sheet metal due to their complex configuration and the limitations associated with forming sheet metal.

### BRIEF SUMMARY OF THE INVENTION

The invention provides a serving lid constructed from both metal and plastic. Because the serving lid is constructed from a combination of materials, the serving lid provides the advantages associated with both metal and plastic serving lids. For example, the serving lid permits lithographic printing to be formed on the outer surfaces of the metal lid and metal cap. The plastic liner or inset also permits the serving lid to be suitably used with plastic or glass containers having threaded exteriors and that may employ a freshness seal.

In one aspect, the invention provides a serving lid assembly for attachment to a container for dispensing product. The serving lid assembly comprises a metal lid having a generally cylindrical sidewall and a lid top, the lid top defining at least one lid dispensing port, a generally cylindrical plastic liner secured to the metal lid, the plastic liner having a connector for connecting the serving lid with the container, and means connected to the metal lid for selectively opening and closing the at least one lid dispensing port.

In another aspect, the invention provides a serving lid assembly as part of a container assembly. The serving lid assembly comprises a container, a metal lid, a plastic lid, and a metal cap. The container has an attachment neck with a non-metal threaded exterior. The metal lid has a skirt and a lid top integrally coupled together by a radially inwardly projecting shoulder. The skirt has a deformed end portion and the lid top includes at least one lid dispensing port. The plastic liner includes a plastic cylindrical wall defining a threaded interior surface, a radially inwardly projecting flange, and a distal end spaced apart on opposing sides of the threaded interior surface. The flange is abutted against the shoulder and the distal end is clamped under the deformed end portion to secure the plastic liner within the metal lid. The threaded interior of the plastic liner is screwed onto the threaded exterior of the container. The metal cap has at least one cap dispensing port. The metal cap is rotatably mounted to the lid top for relative rotation therebetween. The relative rotation between the metal cap and the metal lid permits alignment or misalignment of dispensing portions. As such, the contents of the container are dispensed when the lid dispensing port and the cap dispensing port are aligned. However, the contents are not dispensed with the lid dispensing port and the cap dispensing port are misaligned.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a partially exploded elevation view of an exemplary embodiment of a container assembly with a serving lid and a freshness seal in accordance with the teachings of an embodiment of the present invention;

FIG. 2 is a exploded view of the serving lid assembly of FIG. 1 illustrating a metal cap disengaged from a metal lid;

FIG. 3 is a partially exploded view of another embodiment of a serving lid assembly illustrating a metal cap disengaged from a metal lid;

FIG. 4 is a plan view of the container assembly of FIG. 1 illustrating the serving lid end, which is configured with a dispensing port, a pour port, and a sprinkle port;

FIG. 5 is a cross section of the serving lid assembly of FIG. 4 generally taken along line 5-5 and illustrating the plastic liner secured within the metal lid; and

FIG. 6 is an enlarged portion of the serving lid assembly of FIG. 5 highlighting deformable ribs formed on a sealing surface.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

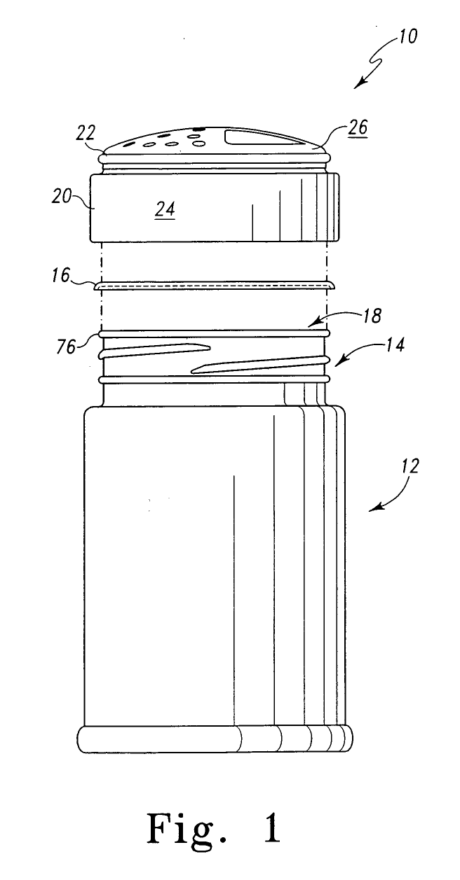

Referring to FIG. 1, a serving lid assembly 10 is illustrated in conjunction with a container 12, which together form a container assembly. As will be more fully explained below, the serving lid assembly 10 is configured to be compatible with any container 12 having a threaded neck 14, which will usually be plastic or glass as shown, but is not material restricted and can be used with any suitable container. The serving lid assembly 10 is uncomplicated to open and close and is preferably easily manipulated between closed and open positions (and back again) using a finger or hand. As such, the serving lid assembly 10 is able to repeatedly dispense the contents of the container 12. Such contents include, but are not limited to granular material such as spices, powders and other similar granular materials. In some cases, the freshness of these contents is maintained through the use of a freshness seal 16 placed over a container opening 18.

As shown in FIG. 1, the serving lid assembly 10 comprises a metal lid 20 and a metal cap 22, both of which may be formed of relatively thin sheet metal such that each component has a relatively constant cross section normal to the metal surface. Each of the metal lid 20 and metal cap 22 are able to receive and hold lithographic prints on their outer surfaces 24, 26. Such lithographic prints can make the serving lid assembly 10 more aesthetically pleasing to a consumer and convey information to the consumer about the contents of the container 12. Such lithography may be beneficially applied on the metal lid 20 and/or metal cap 22. Such lithographic prints may include, but are not limited to, various colors, images, text, and the like.

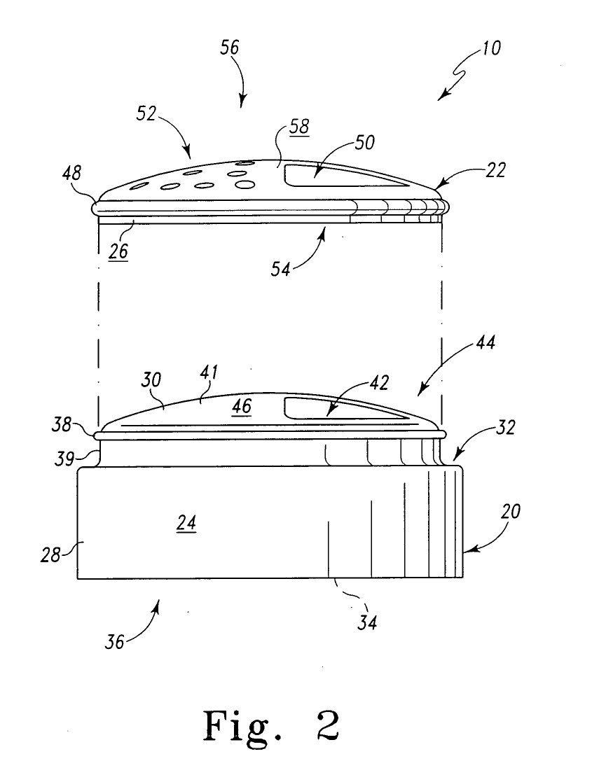

Moving to FIG. 2, the metal lid 20 and metal cap 22 are shown disengaged from each other. As depicted, the metal lid 20 has a generally cylindrical shape and includes a cylindrical sidewall in the form of a skirt 28 and a lid top 30, which is preferably dome shaped/generally convex. In the illustrated embodiment, the outer surface 24 of the metal lid 20 on the skirt 28 is generally smooth, although it may include gripping knurls to facilitate screwing the cap on and off.

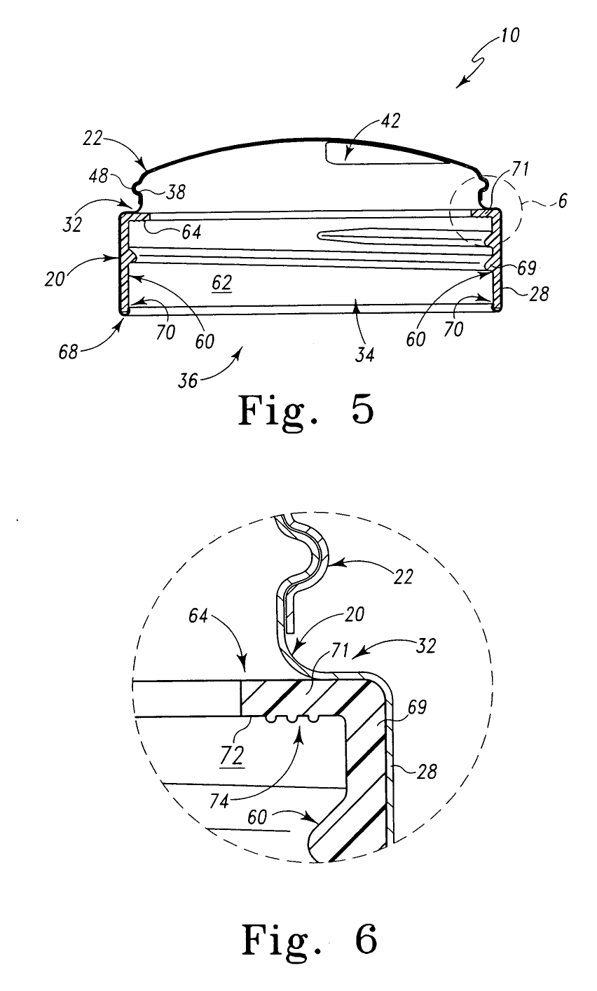

In the illustrated embodiment, the skirt 28 surrounds the periphery of, and depends downward from, the lid top 30. Where the skirt 28 and the lid top 30 are integrally connected to each other they form a radially inwardly projecting shoulder 32. Also, as shown in FIG. 2 (see also FIG. 5), the skirt 28 defines an opening 34 through an underside 36 of the metal lid 20. The opening 34 is particularly sized and dimensioned to receive and mate with the threaded neck 14 of the container 12 (see FIG. 1).

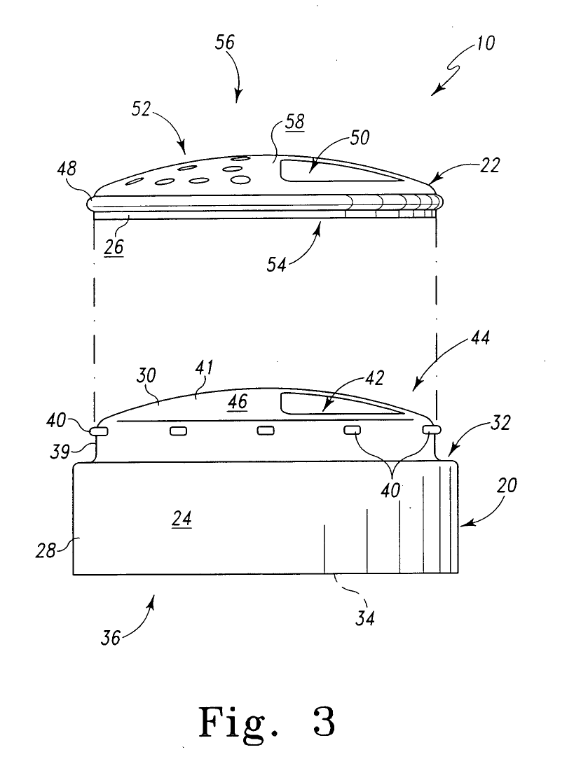

Still referring to FIG. 2, the lid top 30 in the illustrated embodiment is generally dome shaped to include a second smaller diameter cylindrical intermediate sidewall 39 and a convex cover portion 41. As shown, the lid top 30 further includes an outward projecting annular bead 38 formed into intermediate sidewall 39. In the illustrated embodiment, the annular bead 38 is swaged into or otherwise formed in the lid top 30. As such, the annular bead 38 projects radially outwardly and progresses circumferentially and continuously around the lid top 30. In an alternative embodiment as shown in FIG. 3, a plurality of radially outwardly extending swaged detents 40 forming a discontinuous annular bead are used in lieu of the continuous annular bead 38 shown in FIG. 2.

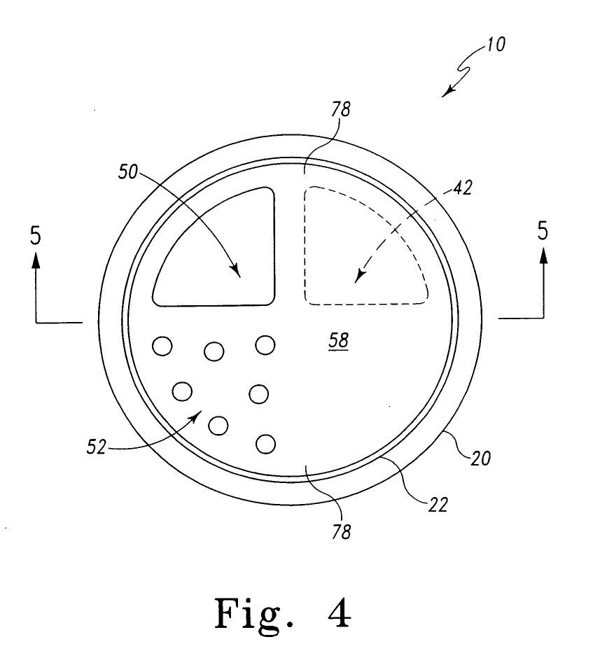

Referring back to FIG. 2, the lid top 30 also includes at least one dispensing port 42 formed through the convex cover portion 41. The dispensing port 42 passes through the lid top 30 from the underside 36 to a top side 44 of the metal lid 20. In the illustrated embodiment, and as best shown in FIG. 4, the dispensing port 42 resembles a quarter circle with rounded corners and occupies about one quarter of a top surface 46 of the lid top 30. Even so, in other embodiments the dispensing port 42 may have various other shapes and sizes to facilitate spooning, pouring, sifting or other dispensing of spices or other such similar granular materials. In one embodiment, more than one dispensing port 42 is formed in the lid top 30. In such cases, each dispensing port 42 may be similarly sized and shaped or, alternatively, each dispensing port may be differently sized and shaped compared to one of the other dispensing ports.

Referring back to FIG. 2, the shape of the metal cap 22 typically closely corresponds to the shape of the lid top 30 such that the general outline shape of these two components approximately match. Therefore, in the illustrated embodiment the metal cap 22 is also generally dome shaped. However, as noted above for the lid top 30, the metal cap 22 may suitable formed in a variety of other shapes such as cylindrical with a flat top surface.

Like the metal lid 20, the metal cap 22 also includes an annular bead 48. In the illustrated embodiment, the annular bead 48 is swaged into or otherwise formed in the metal cap 22. As illustrated, the outer surface of the annular bead 48 is generally smooth. Even so, the outer surface of the annular bead 48 may include a knurl pattern and/or a pattern of grooves. The knurl pattern and/or pattern of grooves, or other gripping structure, permits the metal cap 22 to be more easily gripped and/or rotated relative to the lid top 30. As shown, the annular bead 48 extends radially outwardly and generally progresses circumferentially around the metal cap 22.

As best shown in FIG. 4, the metal cap 22 includes at least one and may include several dispensing ports as shown such as, for example, a pour port 50 and a sprinkle port 52. These ports are smaller than a spoon, however a larger spoon port to receive a spoon and to facilitate spooning of material. Each of the pour port 50 and the sprinkle port 52 passes through the metal cap 22 from the underside 54 to a top side 56 of the metal cap. While the pour port 52 may have various shapes and sizes, in the illustrated embodiment the pour port resembles a quarter circle with rounded corners and occupies about one quarter of a top surface 58 of the metal cap 22. Likewise, while the sprinkle port 52 may have various shapes and sizes, in the illustrated embodiment the sprinkle port is formed from several small, spaced apart circular openings that collectively reside within about another one quarter of the top surface 58 of the metal cap 22. The remaining top sections of the metal cap 22 are solid to provide a means for covering or blocking the lid dispensing port 42 and thereby prevent dispensing of granular material.

Referring back to FIG. 2, the annular bead 48 formed in the metal cap 22 is generally sized and dimensioned to receive the annular bead 38 formed in the lid top 30 of the metal lid 20. In one example, the annular bead 38 is first formed in the cylindrical sidewall 39 of the lid 20, the outer cap 22 is placed upon and over the lid, and the annular bead 48 is formed in the outer cap to correspond to the annular bead 38 (or detents 40) formed in sidewall of the lid. The relatively thin metal of the cap 20 and lid 22 affords these metal forming operations. When the outer cap 22 of the serving lid 10 is placed onto the lid 22, the outer cap is permanently attached to the lid. However, the outer cap is still permitted to rotate relative to the lid (with the application of slight to moderate manual force to overcome frictional engagement between the cap and lid) for selectively dispensing or trapping the contents within the container.

When the metal lid 20 and metal cap 22 are engaged with each other in this manner, axial movement between the metal lid and the metal cap is restricted as noted above. Even so, the metal cap 22 is still permitted to rotate relative to the metal lid 20. However, the rotation is somewhat checked by the force of friction between engaged portions of the metal cap 22 and the metal lid 20. Therefore, once the metal cap 22 is rotated or positioned relative to the metal lid 20, the metal cap generally remains in place until the force of friction is overcome by manual force of a person who wishes to use the spice container.

As shown herein, the cap 56 provides means for opening and closing the lid dispensing port. Other such opening and closing means covered by certain claims appended hereto include a metal cap 22 and metal lid 20 operably coupled together by other connectors such as a rivet (not shown) which may pass through a center of each of the metal cap and the metal lid and secure those components together. In addition, other alternative opening and closing means covered by certain claims appended hereto may include a door (not shown) or other closure. Such a door or other closure can be attached to the metal lid 20 and moveable to alternatively cover and uncover the dispensing port 42.

Still referring to FIG. 5, the serving lid assembly 10 further comprises a plastic liner 60 (a.k.a., a plastic insert). The plastic liner 60 includes a threaded surface 62 that mates and screws onto the thread provided by the threaded neck 14 of the container. Because the plastic liner 60 is formed from plastic, the formation of the threaded interior surface 62 on the plastic liner is relatively simple via plastic molding techniques and, at the very least, commercially feasible. Therefore, the serving lid assembly 10 may be suitably employed with containers 12 made of materials beyond just metal to include plastic and glass and that have a threaded neck 14.

The threaded surface 62 is sized and dimensioned to threadably mate with the threaded neck 14 of the container 12 (FIG. 1). By screwing the metal lid 20 onto the container 12 (FIG. 1), the metal lid and the container are threadably engaged together. Rotation in the opposite direction disengages and releases the metal lid 20 from the container 12 as shown in FIG. 1. Because the metal lid 20 is secured to the container 12 in this fashion, as opposed to the metal lid and the container being joined by a friction or interference fit, a freshness seal 16 (FIG. 1) may be used if desired. In other words, the threaded coupling and uncoupling of the metal lid 20 and the container 12 does not undesirably damage the freshness seal 16.

As shown in FIGS. 5 and 6, the plastic liner 60 is annular in shape to include a cylindrical wall portion 69 and a radially inward annular flange abutment 71. The flange abutment 71 projects radially inward from a top end of the cylindrical wall portion 69 and serves to abut and provide a stop against the terminating lip 76 (FIG. 1) of the container 12. The cylindrical wall portion 69 is concentrically received in and may line the inner surface of the cylindrical skirt 28. The liner 60 is trapped axially between the inward shoulder 32 and the curled rim 68 (a.k.a., curled free end) by engagement with the liner flange 64 at the upper end and lower portion 70 at the bottom end. Preferably, the liner is rigidly secured and not axially slideable once secured between the shoulder 72 and curled free end 68. The curled free end 68 may also be deformed so as affirmatively squeeze and clamp the lower portion 70 of the plastic liner 60 to provide a torque transfer mechanism. As a result when screwing force is applied to the metal lid 20 the torque is transferred to the liner sufficient to prevent rotational slippage between the liner 60 and the lid 20 so that the server lid assembly 10 can be easily screwed on and off the container 12 manually.

As illustrated in FIG. 6, the plastic liner 60 defines a sealing surface 72 on the flange 64. The sealing surface 72 is directed away from the shoulder 32 and toward the opening 34 in the metal lid 20. It may be flat or include ribs to assist in sealing. In the illustrated embodiment, the sealing surface 72 includes a plurality of deformable annular ribs 74. The ribs 74 engage with the terminating lip 76 of the container 12 (or the freshness seal 16 above the lip) and can resiliently deform when the serving lid assembly 10 is threadably mounted onto the container. Therefore, sealing between the other wise planar sealing surface 72 and the lip 76 of the container 12 (or the freshness seal 16 above the lip) is promoted.

Additionally, the reliable threads and surface characteristics afforded by the plastic (which tolerances or configurations cannot be easily be afforded by metal) prevents granular material from spilling or migrating between the threaded interface between the serving lid assembly and the container. As a result, when shaking granular material or otherwise tipping the spice container such granular material is prevented from reaching the threaded interface and then errantly falling out and causing a mess when the spice container is set upright again.

In terms of method of assembly, the plastic liner 60 can inserted and seated within the metal lid 20 by inserting the plastic liner through the opening 34 in the underside 36 of the metal lid (before the curled end 68 is formed). Insertion continues until the radially inwardly projecting flange 64 of the plastic liner 60 abuts the shoulder 32. Because the plastic liner 60 is generally sized and dimensioned to snugly fit within the metal lid 20, the outer surface of the plastic liner 60 may be engaged with the inner surface on the skirt 28 of the metal lid 20. Once the plastic liner 60 is inserted, a the free end of the metal lid 20 is deformed radially inwardly and curled over a lower portion 70 of the plastic liner 60 to form curled end 68. This biases the flange 64 against the shoulder 32 to establish the radially inward annular flange abutment 71, prevents the plastic liner 60 from rotating relative to the metal lid 20, and/or generally secures the plastic liner 60 within the metal lid 20. The curled end 68 of the metal lid 20 can be formed at the same time as the annular bead 38 is swaged or otherwise formed in the metal lid 20, or can be formed after or prior to formation of annular bead 38. Preferably, the bead 38 in the metal lid 20 is formed prior to insertion of the plastic liner 60.

In operation, the serving lid assembly 10 is threadably mated to the container 12 to form a spice container assembly. As such, the serving lid assembly 10 is able to selectively dispense or retain the contents of the container 12. To pour out the contents of the container 12, the metal cap 22 is rotated relative to the metal lid 20 until the dispensing port 42 and the pour port 50 are either partially or fully aligned. With the dispensing port 42 uncovered, the container 12 is tipped or turned over from the orientation of the container shown in FIG. 1. When this occurs, the contents of the container 12 are able to freely flow through the dispensing port 42 and the pour port 50.

In similar fashion, to sprinkle out the contents of the container 10, the metal cap 22 is rotated relative to the metal lid 20 until the dispensing port 42 and the sprinkle port 52 are either partially or fully aligned. Thereafter, the container 12 is turned or tipped over from the orientation of the container shown in FIG. 1. With the dispensing port 42 uncovered, the contents of the container 12 flow through the dispensing port 42 and the sprinkle port 52 at a metered rate that is someone less than the free flow noted above when the pour port 50 aligns with the dispensing port.

When the contents of the container 12 are to be held within the container and not dispensed therefrom, the metal cap 22 is rotated relative to the metal lid 20 until the dispensing port 42 is misaligned with both the pour port 50 and the sprinkle port 52 and covered by a solid portion 78 of the metal cap. As such, even when the container 12 is turned or tipped over from the orientation of the container shown in FIG. 1, none of the contents are dispensed from the container.

Also, where all, a substantial portion, or a measured amount of the contents of the container 12 are to be dispensed or made available, the metal lid 20 is rotated relative to the container until the serving lid assembly 10 and the container threadably disengage from each other. Thereafter, a spoon or other utensil (not shown) is inserted into the opening 18 of the container 12 and a measured portion (e.g., teaspoon, tablespoon, etc.) of the contents may be withdrawn from the container. This is particularly beneficial if the dispensing port 42 and the pour port 50 are each too small to accommodate the chosen or available utensil. Alternatively, when the serving lid assembly 10 is entirely removed from the container, the container 12 may be tipped over to pour out the needed amount of the contents.

From the foregoing, those skilled in the art will recognize that the metal and plastic serving lid assembly 10 permits lithographic printing to be formed on the outer surfaces 24, 26 of the metal lid 20 and metal cap 22. In addition, the serving lid assembly 10 is suitably used with plastic or glass containers, such as container 12, having threaded exteriors. Because the serving lid assembly 10 is formed from a combination of materials, the serving lid is able to provide the advantages associated with both metal and plastic.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A serving lid assembly for attachment to a container and for dispensing product, comprising:
a metal lid having a generally cylindrical sidewall and a lid top, the lid top defining at least one lid dispensing port,
a generally cylindrical plastic liner secured to the metal lid, the plastic liner having a connector for connecting the serving lid with the container; and
means connected to the metal lid for selectively opening and closing the at least one lid dispensing port.

2. The serving lid assembly of claim 1, wherein the metal lid includes a radially inwardly projecting shoulder formed between the sidewall and the lid top, and an inwardly formed portion spaced below the shoulder, the plastic liner trapped axially between the shoulder and the inwardly formed portion.

3. The serving lid assembly of claim 2, wherein the inwardly formed portion is a terminating curled free end of the metal lid.

4. The serving lid assembly of claim 3, wherein the plastic liner includes a radially inwardly projecting flange, the flange defining a sealing surface on an underside thereof adapted to prevent container contents from spilling when in use.

5. The serving lid assembly of claim 4, further comprising at least one circular rib on the sealing surface for resiliently deforming for sealing purposes.

6. The serving lid assembly of claim 2, wherein the connector is at least one thread and wherein the metal lid is sufficiently engaged with the cylindrical plastic liner to afford torque transfer therebetween so that manual screw force applied to the metal lid will be transmitted to the plastic liner.

7. The serving lid assembly of claim 1, wherein the means for selectively opening and closing the lid dispensing port is a metal cap fit onto the metal lid, the metal cap having at least one dispensing port.

8. The serving lid assembly of claim 7, wherein the metal cap and the metal lid are rotatably coupled together through a pair of radially outwardly projecting and interfitting discontinuous or continuous circular beads.

9. The serving lid assembly of claim 7, wherein the cap and the lid top are generally dome shaped, the metal lid including a convex portion and an intermediate annular sidewall portion connecting the skirt with the convex portion, the cap including a convex cover portion and a surrounding annular wall depending downward from the convex cover portion, the surrounding annular wall surrounding the intermediate annular sidewall portion.

10. The serving lid of claim 7, wherein lithography is printed on the metal cap.

11. A serving lid assembly as part of a container assembly, comprising:
a container having an attachment neck with a non-metal threaded exterior;
a metal lid having a skirt and a lid top integrally coupled together by a radially inwardly projecting shoulder, the skirt having a deformed end portion, the lid top including at least one lid dispensing port;
a plastic liner including a cylindrical wall defining a threaded interior surface and a radially inwardly projecting flange and a distal end spaced apart on opposing sides of the threaded interior surface, the flange abutted against the shoulder and the distal end clamped under the deformed end portion to secure the plastic liner within the metal lid, the threaded interior of the plastic liner being screwed onto the threaded exterior of the container; and
a metal cap having at least one cap dispensing port, the metal cap rotatably mounted to the lid top for relative rotation therebetween, wherein relative rotation between the metal cap and the metal lid permits alignment or misalignment of dispensing portions such that contents of the container are dispensed when the lid dispensing port and the cap dispensing port are aligned and not dispensed with the lid dispensing port and the cap dispensing port are misaligned.

12. The serving lid assembly of claim 11, wherein the metal cap and the metal lid mate along a circular interface for relative rotation therebetween and are axially secured together by a pair of radially outwardly projecting continuous or discontinuous mating annular beads.

13. The serving lid assembly of claim 12, wherein the flange includes a sealing surface directed away from the shoulder, the sealing surface engaging at least one of a lip formed on the neck of the container and a freshness seal.

14. The serving lid assembly of claim 13, wherein the sealing surface includes at least one thin deformable annular rib.

15. The serving lid assembly of claim 11, wherein the deformed end portion is a curled terminating edge that is curled radially inwardly over the bottom portion of the plastic liner to retain the plastic liner.

16. The serving lid assembly of claim 11, wherein the cap and the lid top are generally dome shaped, the metal lid including a convex portion and an intermediate annular sidewall portion connecting the skirt with the convex portion, the cap including a convex cover portion and a surrounding annular wall depending downward from the convex cover portion, the surrounding annular wall surrounding the intermediate annular sidewall portion.

17. The serving lid assembly of claim 11 wherein the container contains spice material contents or other comparable granular material contents and wherein the dispensing ports are configured for at least one of manual shaking, pouring and spooning.
